(19) United States
(12) Patent Application Publication
(10) Pub. No.: US 2007/0038740 A1
(43) Pub. Date: Feb. 15, 2007

(54) Notification service

(75) Inventor: Ronald Steeves, Ottawa (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 11/201,245

(22) Filed: Aug. 10, 2005

(51) Int. Cl. G06F 15/173

(52) U.S. Cl. 709/224

(57) ABSTRACT

The present invention provides a flexible and dynamic notification system. A service node acts as a contact proxy for a subscriber, wherein each subscriber has various actual notification addresses associated with different networks or communication terminals. For each subscriber, the service node supports a common notification address, which is used by various notification services to send notification messages to the subscriber. Upon receipt of a notification message to a subscriber's common notification address, the service node will send the notification message to an appropriate one or more of the subscriber's actual notification addresses. The actual notification address may be predefined or may be selected based on various criteria, including a defined subscriber profile or presence information associated with the subscriber. Different actual notification addresses may be selected at any given time based on the selection criteria. Further, the service node may simultaneously forward multiple messages to different actual notification addresses.

### FIELD OF THE INVENTION

The present invention relates to communications, and in particular to providing a contact proxy to which notification messages for a subscriber are sent and then forwarded to an appropriate address.

### BACKGROUND OF THE INVENTION

Current notification systems allow notification messages to be sent to pre-selected communication terminals over the particular network associated with the communication terminal. Given the increasing mobility of users and the number of potential communication terminals associated with these users, a user may not be reachable when a notification message is sent to the pre-selected communication terminal. For example, an email notification addressed to a user's work email may go unnoticed if the user is out of the office for lunch, for the weekend, or on vacation. This is particularly frustrating when the user may have a mobile terminal capable of receiving voice, short messaging service, instant messaging, or email messages. However, if the user did not pre-select the mobile terminal as a destination for receiving the notification messages, the notification message will go unnoticed until the user checks her work email.

Requiring the user to provide multiple destinations for notification messages to each of several notification services is cumbersome, and often impossible. Certain notification services may be configured to send only certain message types or message formats, which are incompatible with certain of the user's communication terminals or networks through which the user's communication terminals are supported. Even if the notification services accept multiple destinations and can support various message types and formats, keeping each of the notification services up to date when addresses for the user's communication terminals are changed, added, or deleted is at best cumbersome and burdensome.

Accordingly, there is a need for a technique to minimize the burden on a user in managing and maintaining addressing used for receiving notification messages, while increasing the probability that the notification addresses will be delivered in a timely fashion to an appropriate communication terminal of the user. There is a further need to facilitate delivery of notification messages in a different message type or format than the format in which the original message was sent.

### SUMMARY OF THE INVENTION

The present invention provides a flexible and dynamic notification system. A service node acts as a contact proxy for a subscriber, wherein each subscriber has various actual notification addresses associated with different networks or communication terminals. For each subscriber, the service node supports a common notification address, which is used by various notification services to send notification messages to the subscriber. Upon receipt of a notification message to a subscriber's common notification address, the service node will send the notification message to an appropriate one or more of the subscriber's actual notification addresses. The actual notification address may be predefined or may be selected based on various criteria, including a defined subscriber profile or presence information associated with the subscriber. Different actual notification addresses may be selected at any given time based on the selection criteria. Further, the service node may simultaneously forward multiple messages to different actual notification addresses.

The service node may also translate the notification messages to effectively reformat or otherwise process the original notification message prior to forwarding the notification message to the actual notification address, in order to allow the message to be properly delivered to and received by the appropriate communication terminal or terminals. For example, original notification messages in the form of an email, short message service message, or instant messaging message may be converted to an audio message, and vice versa. Further, text-based messages may be converted from one format to another, such as by converting a short messaging service message to an email or an instant message, or vice versa. The service node may cooperate with other entities to facilitate such processing and delivery of notification messages to the actual notification addresses.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is a flow diagram illustrating operation of a notification server according to one embodiment of the present invention.

FIG. 3 is a flow diagram illustrating operation of a contact proxy according to one embodiment of the present invention.

FIG. 4 is a block representation of a notification server according to one embodiment of the present invention.

FIG. 5 is a block representation of a service node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

In general, the present invention provides a contact proxy through which notification messages are forwarded to an appropriate subscriber. The contact proxy supports a common notification address, which is associated with the subscriber and used by notification services to send notification messages to the subscriber. The contact proxy will receive notification messages directed to the common notification address of the subscriber, access an actual notification address for the subscriber, and send the notification message to the subscriber using the actual notification address. The notification message may be forwarded to multiple addresses at the same time. Selection of the actual notification address or addresses may be predefined or selected from a list based on various types of criteria, including rules derived from a subscriber profile or presence information that bears on the relative availability of the subscriber for communications at different subscriber terminals. With the present invention, changes in the subscriber's actual notification addresses, which are associated with the subscriber's terminals, can be made at the contact proxy, wherein the common notification addresses at the notification services need not change. Therefore, adding, changing, or removing an actual notification address associated with the subscriber will not require each of the notification services to be updated. Only an update at the contact proxy is required.

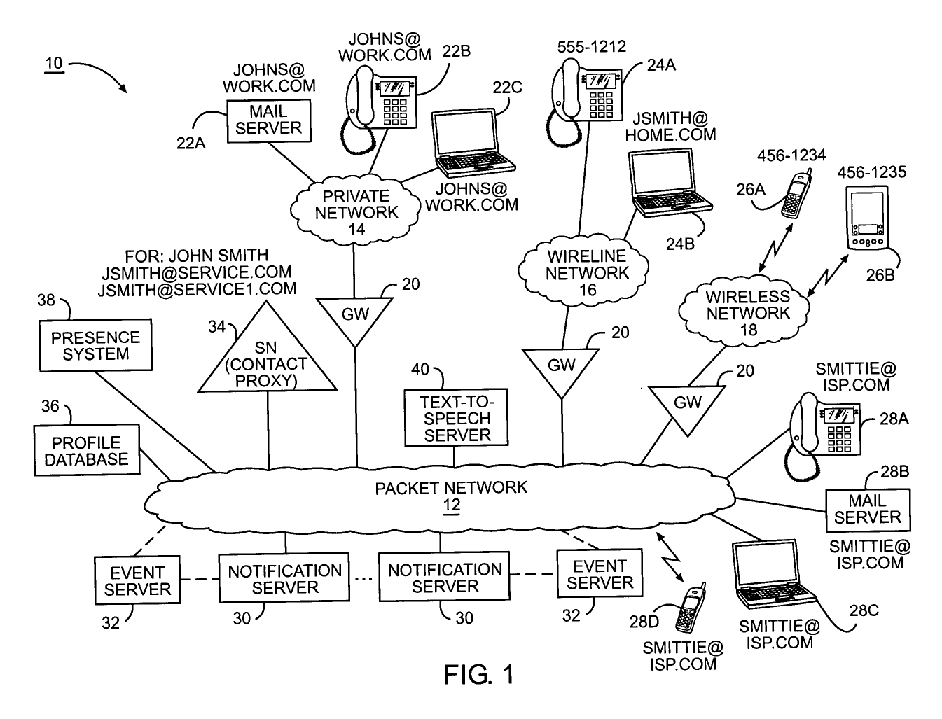

Prior to delving into the details of the present invention, an overview of an exemplary communication environment 10 according to one embodiment of the present invention is described in association with FIG. 1. The communication environment 10 is centered about a packet network 12, which is capable of interacting with any number of networks, including a private network 14, a wireline network 16, or wireless network 18, via an appropriate gateway (GW) 20. The various networks may implement different types of communication technologies, including circuit-switched or packet based communication techniques, as well as have any combination of wired or wireless aspects. As such, the wireline network 16 may support local wireless or cellular communications through appropriate wireless local area network (WLAN) or cellular access networks (not shown). Further, the wireless network 18 may include a wireline core, and the private network 14 may include various combinations of wired and wireless networks supporting both circuit and packet based communications. The private network 14 is illustrated to generally represent enterprise-like networks, which are often supported by a private branch exchange (PBX).

For purposes of illustration, assume that a given subscriber, referred to as John Smith, is a prolific communicator and is associated with various communication terminals 22, 24, 26, 28, which are primarily supported by different ones of the private network 14, wireline network 16, wireless network 18, and packet network 12. Depending on the supporting network configuration, different ones of the communication terminals associated with John Smith may be associated with the same or different communication addresses, as those skilled in the art will appreciate. For the sake of conciseness and clarity, assume that the private network terminals 22A, 22B, and 22C represent a mail server, telephone, and personal computer, respectively, each of which share an actual notification address of JohnS@work.com. Wireline network terminals 24A and 24B representing a telephone and a personal computer, respectively, are associated with actual notification addresses of 555-1212, a directory number, and JSmith@home.com. The wireless network 18 may support wireless network terminals 26A and 26B, which are a cellular telephone having an actual notification address of 456-1234 and a personal digital assistant having an actual notification address of 456-1235, respectively. The packet network 12 may support packet network terminals 28A, 28B, 28C, and 28D, which represent a voice-over-packet (VoP) telephone, mail server, personal computer, and mobile terminal, respectively. Each of the packet network terminals 28 is assumed to be associated with an actual notification address of Smittie@ISP.com. As shown, the actual notification address may take various forms and may include Internet Protocol (IP) addresses, Session Initiation Protocol (SIP) addresses, H.323 addresses, and traditional directory numbers. Those skilled in the art will recognize other communication addresses that are directly or indirectly used for establishing communications with a subscriber, or at least sending a message to a subscriber.

For the present invention, various notification services may be used to generate notification messages intended for the subscriber, John Smith. These notification services are represented by notification servers 30, which may be associated with various event servers 32. The event servers 32 may monitor various events and send triggers to the notification servers 30. Upon receiving an event trigger, the notification servers 30 may generate a notification message for the subscriber and send the message to a communication address associated with the subscriber.

The notification messages sent from the notification server 30 toward the subscriber will be sent to a common notification address, which is supported by a contact proxy provided by a service node 34 and associated with the subscriber. Acting as a contact proxy, the service node 34 will receive notification messages on behalf of the subscriber, and then forward those messages to an appropriate one of the actual notification addresses to facilitate delivery of the notification message to the subscriber. In the illustrated example, John Smith is associated with two common notification addresses: Jsmith@service.com and Jsmith@service1.com. From the notification server's perspective, the common notification addresses are generally the only addresses associated with the subscriber.

In determining an appropriate actual notification address to which the notification messages for the subscriber are forwarded, the subscriber's profile may be accessed from a profile database 36 to determine the actual notification address for the subscriber, or to obtain rules from which the actual notification address can be determined. Further, the service node 34 may access a presence system 38, which keeps track of the relative availability of the subscriber for receiving communications. Based on the subscriber's presence, an actual notification address may be selected to increase the likelihood that the notification address will be delivered to a communication terminal that the subscriber is currently using or is likely to gain access to in the near future. Once the actual notification address to use for sending the notification message to the subscriber is determined, the notification message is sent using the actual notification address.

In forwarding the notification message, the notification message may be processed in a variety of ways to accommodate the network server through which the notification message will travel, or the communication terminals at which the notification message will be received. Further, the service node 34 may interact with other entities to help facilitate such processing. One example is a text-to-speech server 40, which can take text-based messages, convert those messages into an audible format, and present the audible notification message to a communication terminal or an associated recording device, such as a voicemail system. Similarly, audio-based messages may be converted to a text-based message, and text-based messages may be transformed from one message type to another. For example, email or instant messaging messages may be transformed into a Short Message Service (SMS) message, and vice versa. Virtually any type of transformation is plausible.

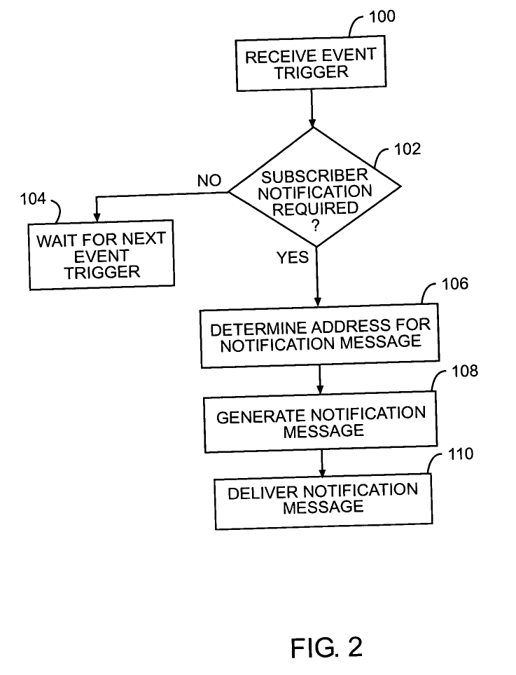

Turning now to FIG. 2, a flow diagram is provided to illustrate the basic operation of a notification server 30 according to one embodiment of the present invention. Initially, the notification server 30 will receive an event trigger from an internal process or an external entity, such as an event server 32 (step 100). The notification server 30 will then determine whether subscriber notification is required in light of the event trigger (step 102). For any given event, different subscribers may be effected in different ways, wherein certain events may only require that notification messages be sent to certain subscribers. If subscriber notification is not required, the notification server 30 will wait for the next event trigger to be received (step 104).

If subscriber notification is required (step 102), the notification server 30 will determine an address to which a notification message should be sent (step 106). The address selected for the subscriber will be the common notification address, which is associated with the subscriber and supported by the service node 34. The notification server 30 will then generate the notification message (step 108) and deliver the notification message to the service node 34, which is acting as the contact proxy for the subscriber (step 110). As illustrated in FIG. 1, the common notification address for John Smith is either JSmith@service.com or JSmith@service1.com. The different common notification addresses may be used to trigger different rules to apply when selecting an actual notification address at the service node 34. For example, a first common notification address may be used for work-related notifications, wherein the second common notification address may be used for personal notifications. The different common notification addresses could also be used to help the service node 34 to apply different priorities, rules, or other selection criteria when determining or otherwise selecting an actual notification address or addresses to which the notification message can be forwarded to the subscriber.

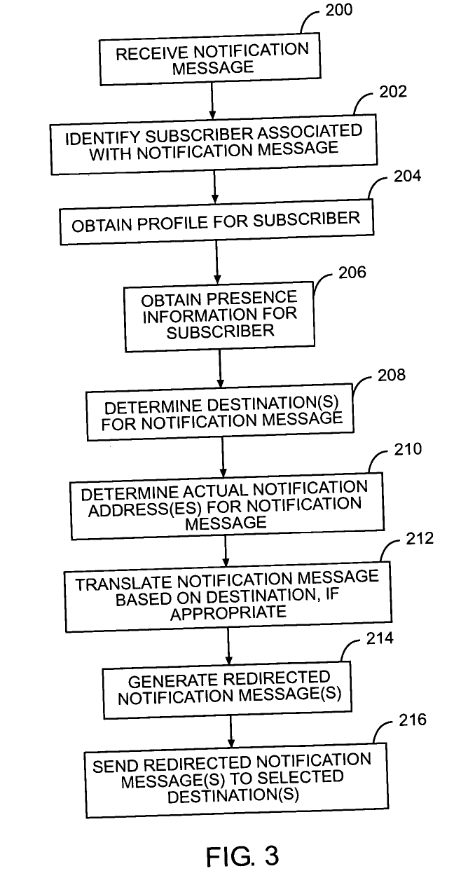

Turning now to FIG. 3, a flow diagram illustrating the basic operation of the service node 34, when acting as a contact proxy, is illustrated according to one embodiment of the present invention. Initially, the service node 34 will receive the notification message (step 200). The service node 34 will process the received notification message, perhaps by identifying the common notification address associated with the notification message, to identify the subscriber associated with the notification message (step 202). In an effort to determine an appropriate actual notification address to use for forwarding the message, the service node 34 may obtain a profile for the subscriber (step 204), as well as obtain any presence information for the subscriber (step 206). Based on the profile, the presence information, any other selection criteria, or a combination thereof, the service node 34 will determine one or more destinations for the notification message (step 208). Based on the destinations, the appropriate actual notification address or addresses to which the notification message should be redirected are determined (step 210).

Once the actual notification addresses are selected, the service node 34 will provide any translations of the notification message, if appropriate, based on the ultimate destination of the notification message (step 212). These translations may include converting the body of the notification message from one format to another, such as from a text format to a voice format, as well as translating message types, such as from an email to an instant message. After the translations, the service node 34 will generate redirected notification messages based on the original notification message step 214) and then send the redirected notification message or messages to the selected destination or destinations (step 216). Notably, multiple redirected notification messages are created when different formats are required. Otherwise, only a single redirected notification message is sent or a single redirected notification message is sent to multiple communication terminals. For example, multiple instant messages or multiple emails may be sent to different terminals having the same or different actual notification address.

With the present invention, the various notification services may be provided with a relatively fixed common notification address, wherein the contact proxy implemented by the service node 34 may be updated periodically as actual notification addresses are added, removed, or changed in association with the subscriber. As such, the subscriber has a single point of contact for implementing changes associated with the actual notification addresses. The common notification addresses may stay in place for extended periods of time or indefinitely.

As indicated above, the contact proxy may use different rule sets or criteria in selecting actual notification addresses based on the common notification address used for sending the original notification message from the notification service. Having different common notification addresses may assist the contact proxy in processing the notification message. Preferences may relate to the relative availability of a subscriber to receive communications, the likelihood of being able to access the subscriber at a particular communication terminal at any given time, the originator of the notification message, the nature of the notification message, the time or the date, whether the notification message is associated with home, work, school, or other personal events, or any other desired criteria. With the present invention, subscribers are given more flexibility in altering their actual notification addresses without impacting previously established notification services. Further, the notification messages are not relegated to being delivered in the same format or the same manner in which the original notification message is initiated. The ability to use various rules in determining when, where, and how to redirect notification messages increases the likelihood that the notification messages will be received in a timely fashion. As such, notification messages such as a meeting notice, an indication that a large credit card purchase is being made, or an alerted about an accident at school have a greater likelihood of being properly received and responded to in an appropriate fashion.

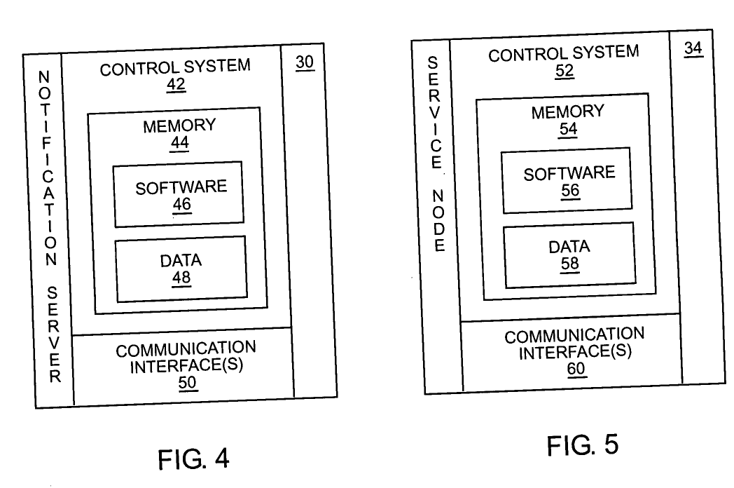

With reference to FIG. 4, a block representation of a notification server 30 is provided. The notification server 30 may include a control system 42 having sufficient memory 44 for the requisite software 46 and data 48 to operate as described above. The control system 42 may include one or more communication interfaces 50 to facilitate communications with other entities.

With reference to FIG. 5, a block representation of a service node 34 is provided. The service node 34 may include a control system 52 having sufficient memory 54 for the requisite software 56 and data 58 to operate as described above. The control system 52 may include one or more communication interfaces 60 to facilitate communications with other entities.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving a first notification message intended for a user from a notification service, the notification message directed to a common notification address associated with the user;
determining an actual notification address to use for sending a second notification message based on the first notification message to the user; and
sending the second notification message based on the first notification message to the user.

2. The method of claim 1 wherein a plurality of actual notification addresses is associated with the user, and determining the actual notification address comprises selecting the actual notification address from the plurality of actual notification addresses.

3. The method of claim 2 wherein the actual notification address is selected based on indicia dependent on variable criteria such that different ones of the plurality of actual notification addresses may be selected as the criteria vary.

4. The method of claim 3 wherein the indicia is a user profile and the actual notification address is selected based on the user profile and further comprising accessing the user profile based on the common notification address.

5. The method of claim 3 wherein the indicia is presence information bearing on a relative availability of the user to receive communications, and the actual notification address is selected based on the presence information and further comprising accessing the presence information based on the common notification address.

6. The method of claim 2 wherein the user is associated with a plurality of common notification addresses and the actual notification address selected will vary based on the common notification address to which the first notification message is delivered.

7. The method of claim 1 wherein the actual notification addresses is determined based on the common notification address.

8. The method of claim 1 wherein a plurality of actual notification addresses associated with the user are selected and a plurality of second notification messages are sent to different communication terminals associated with the user using the plurality of actual notification addresses.

9. The method of claim 1 further comprising processing the first notification message to generate a translation message, wherein the translation message has a different message format than the first notification message.

10. The method of claim 1 further comprising processing the first notification message to generate the translation message, wherein the translation message has a different message type than the first notification message.

11. The message of claim 10 wherein the processing converts the first notification message to a voice message from a text message or to a text message from a voice message.

12. The method of claim 1 wherein the first notification message could not be sent directly to the user using the actual notification address due to terminal, network, format, or type-based incompatibility.

13. A contact proxy comprising:
at least one communication interface; and
a control system associated with the at least one communication interface and adapted to:
receive a first notification message intended for a user from a notification service, the first notification message directed to a common notification address associated with the user;
determine an actual notification address to use for sending a second notification message based on the first notification message to the user; and
send the second notification message based on the first notification message to the user.

14. The contact proxy of claim 13 wherein a plurality of actual notification addresses is associated with the user, and wherein to determine the actual notification address the control system is further adapted to select the actual notification address from the plurality of actual notification addresses.

15. The contact proxy of claim 14 wherein the actual notification address is selected based on indicia dependent on variable criteria, such that different ones of the plurality of actual notification addresses may be selected as the criteria vary.

16. The contact proxy of claim 15 wherein the indicia is a user profile, the actual notification address is selected based on the user profile, and the control system is further adapted to access the user profile based on the common notification address.

17. The contact proxy of claim 15 wherein the indicia is presence information bearing on a relative availability of the user to receive communications, the actual notification address is selected based on the presence information, and the control system is further adapted to access the presence information based on the common notification address.

18. The contact proxy of claim 14 wherein the user is associated with a plurality of common notification addresses, and the actual notification address selected will vary based on the common notification address to which the first notification message is delivered.

19. The contact proxy of claim 13 wherein the actual notification addresses is determined based on the common notification address.

20. The contact proxy of claim 13 wherein a plurality of actual notification addresses associated with the user are selected and a plurality of second notification messages are sent to different communication terminals associated with the user using the plurality of actual notification addresses.

21. The contact proxy of claim 13 wherein the control system is further adapted to process the first notification message to generate a translation message, wherein the translation message has a different message format than the first notification message.

22. The contact proxy of claim 13 wherein the control system is further adapted to process the first notification message to generate a translation message, wherein the translation message has a different message type than the first notification message.

23. The contact proxy of claim 22 wherein to process the first notification message, the control system is further adapted to convert the first notification message to a voice message from a text message or to a text message from a voice message.

24. The contact proxy of claim 13 wherein the first notification message could not be sent directly to the user using the actual notification address due to terminal, network, format, or type-based incompatibility.
